(19) United States
(12) Patent Application Publication
(10) Pub. No.: US 2019/0073136 A1
(43) Pub. Date: Mar. 7, 2019

(54) MEMORY CONTROLLING METHOD, MEMORY CONTROLLING CIRCUIT AND MEMORY SYSTEM

(71) Applicant: MACRONIX INTERNATIONAL CO., LTD., Hsinchu (TW)

(72) Inventors: Hung-Sheng Chang, Taipei City (TW); Hsiang-Pang Li, Zhubei City (TW); Tse-Yuan Wang, Kinmen County (TW); Che-Wei Tsao, Yuanlin City (TW); Yuan-Hao Chang, Taipei City (TW); Tei-Wei Kuo, New Taipei City (TW)

(21) Appl. No.: 15/696,325

(22) Filed: Sep. 6, 2017

(51) Int. Cl. G06F 3/06

(52) U.S. Cl. CPC G06F 3/0611; G06F 3/0679; G06F 3/0659

(57) ABSTRACT

A memory controlling method, a memory controlling circuit and a memory system are provided. A memory includes a plurality of memory chips. The memory controlling method includes the following steps: The memory chips are grouped into at least two partner groups by a grouping unit. A quantity of the memory chips in each of the partner groups is at least two. At least one of the memory chips in each of the partner groups is required to serve a reading request or a writing request by a processing unit.

### TECHNICAL FIELD

The disclosure relates in general to a controlling method and a controlling circuit, and more particularly to a memory controlling method, a memory controlling circuit and a memory system.

### BACKGROUND

Along with the development of the semiconductor technology, various memories are invented. Digital data can be stored in the memory, such that the memory is widely used in electronic devices.

However, in a NAND flash, a garbage collection operation and a wear-leveling operation may increase the response time. In a phase change memory (PCM), a refresh operation may increase the response time. Therefore, how to minimize the response time is a way to achieve the quality of service (Qos).

### SUMMARY

The disclosure is directed to a memory controlling method, a memory controlling circuit and a memory system. At least one of a plurality of memory chips in each partner group is required to serve a reading request or a writing request, such that the garbage collection operation, the wear-leveling operation and the refresh operation will not increase the response time and the quality of service (Qos) can be achieved.

According to one embodiment, a memory controlling method is provided. A memory includes a plurality of memory chips. The memory controlling method includes the following steps: The memory chips are grouped into at least two partner groups by a grouping unit. A quantity of the memory chips in each of the partner groups is at least two. At least one of the memory chips in each of the partner groups is required to serve a reading request or a writing request by a processing unit.

According to another embodiment, a memory controlling circuit is provided. A memory includes a plurality of memory chips. The memory controlling circuit includes a grouping unit and a processing unit. The grouping unit is used for grouping the memory chips into at least two partner groups. A quantity of the memory chips in each of the partner groups is at least two. The processing unit is used for requiring at least one of the memory chips in each of the partner groups to serve a reading request or a writing request.

According to another embodiment, a memory system is provided. The memory system includes a plurality of memory chips and a memory controlling circuit. The memory controlling circuit includes a grouping unit and a processing unit. The grouping unit is used for grouping the memory chips into at least two partner groups. A quantity of the memory chips in each of the partner groups is at least two. The processing unit is used for requiring at least one of the memory chips in each of the partner groups to serve a reading request or a writing request.

### BRIEF DESCRIPTION OF THE DRAWINGS

FIG. 1 shows a memory.

FIG. 2 shows another memory.

FIG. 3 shows a partner group configuration of a memory.

FIG. 4 shows a memory system.

FIG. 5 shows a flowchart of a memory controlling method.

FIG. 6 illustrates an exemplary example of the memory controlling method.

FIG. 7 shows a flowchart of a memory controlling method.

FIG. 8 illustrates a multi-level linked list.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

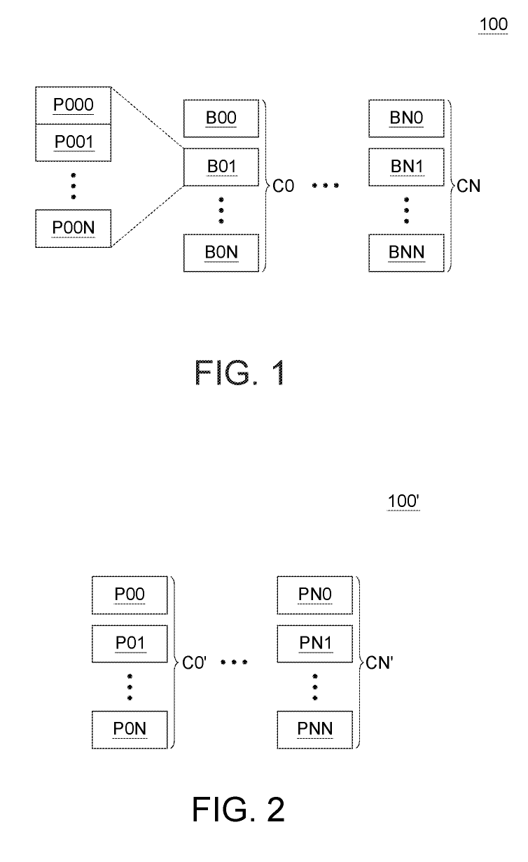

Please refer to FIG. 1, which shows a memory 100. The memory 100 is a nonvolatile memory, such as a NAND flash, a NOR flash, a phase change memory, a magnetic RAM, or a resistive RAM. In the configuration of the memory 100, the memory 100 may include a plurality of memory chips C0, . . . , CN. The memory chip C0 may be organized by blocks B00, B01, . . . , B0N. The memory chip CN may be organized by blocks BN0, BN1, . . . , BNN. The block B00 may be organized by pages P000, P001, . . . , P00N.

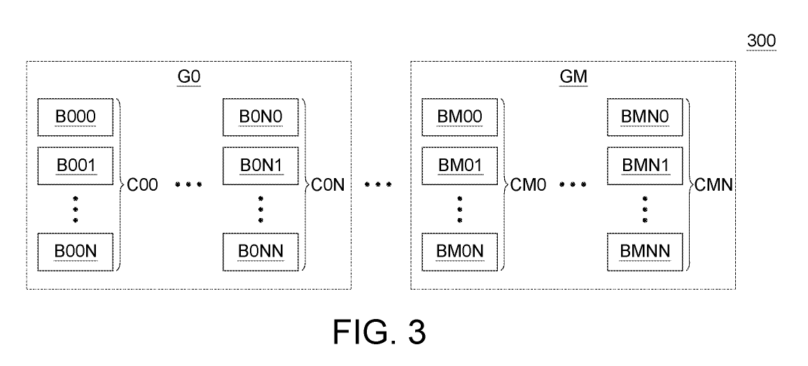

Please refer to FIG. 2, which shows another memory 100′. In the memory 100′, the memory chip C0′ may be organized by pages P00, P01, . . . , P0N, and the memory chip CN′ may be organized by pages PN0, PN1, . . . , PNN.

That is to say, each memory chip could be organized by small/large configuration (such as page/block, sector/block, sector/page), small configuration (such as sector, page), or large configuration (such as block). In FIG. 1, the memory 100 is organized by small/large configuration. In FIG. 2, the memory 100′ is organized by small configuration. In the memory 100, each of the memory chips C0, . . . , CN is the basic unit for serving a reading request or a writing request. In the memory 100′, each of the memory chips C0′, . . . , CN′ is the basic unit for serving the reading request or the writing request.

If too many memory chips C0, . . . , CN (or C0′, . . . , CN′) are being performed high latency operation, such as the garbage collection operation, the wear-leveling operation, or the refresh operation, at the same time, the response time for the reading request and the writing request will be increased. Therefore, it is needed to ensure that the reading request or the writing request can be performed on at least one of the memory chips C0, . . . , CN (or C0′, . . . , CN′).

Please refer to FIG. 3, which shows a partner group configuration of a memory 300. The memory 300 includes a plurality of memory chips C00, . . . , C0N, . . . , CM0, . . . , CMN. The memory chips C00, . . . , C0N, . . . , CM0, . . . , CMN are grouped into at least two partner groups G0, . . . , GM. The quantity of the memory chips C00, . . . , C0N, . . . , CM0, . . . , CMN in each of the partner groups G0, . . . , GM is at least two. In FIG. 3, the quantity of the partner groups G0, . . . , GM is M+1. The quantity of the memory chips C00, . . . , C0N in the partner groups G0 is N+1 and the quantity of the memory chips CM0, . . . , CMN in the partner groups GM is N+1.

The memory chip C00 is organized by blocks B000, B001, . . . , B00N. The memory chip C0N is organized by blocks B0N0, B0N1, . . . , B0NN. The memory chip CM0 is organized by blocks BM00, BM01, . . . , BM0N. The memory chip CMN is organized by blocks BMN0, BMN1, . . . , BMNN.

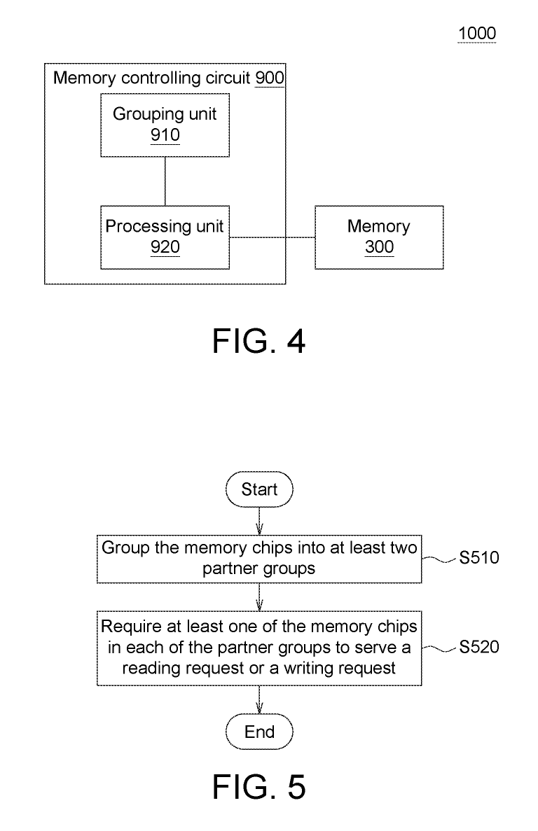

Please refer to FIG. 4, which shows a memory system 1000. The memory system 1000 includes a memory controlling circuit 900 and the memory 300. The memory controlling circuit 900 includes a grouping unit 910, a processing unit 920. The grouping unit 910 is used for grouping the memory chips C00, . . . , C0N, . . . , CM0, . . . , CMN. The processing unit 920 is used for controlling the memory chips C00, . . . , C0N, . . . , CM0, . . . , CMN. The grouping unit 910 is further used for storing data, such as the grouping relationship of the memory chips C00, . . . , C0N, . . . , CM0, . . . , CMN. The operation of the memory controlling circuit 900 is illustrated by a flowchart as below.

Please refer to FIG. 5, which shows a flowchart of a memory controlling method. In step S510, the grouping unit 910 groups a plurality of memory chips into at least two partner groups. Taken the FIG. 3 as an example, the grouping unit 910 groups (N+1)*(M+1) chips C00, . . . , C0N, . . . CM0, . . . , CMN into M+1 partner groups G0, . . . , GM. The grouping unit 910 may group the memory chips according to the number of the memory chips. For increasing the efficiency of parallel processing, the number of the partner groups can be increased and the number of the memory chips in each of the partner groups can be decreased. For increasing the flexibility of performing operations, the number of the memory chips in each of the partner groups can be increased and the number of the partner groups can be decreased.

In one embodiment, the quantities of the memory chips in the partner groups are identical. For example, in FIG. 3, the quantity of the memory chips C00, . . . , C0N in the partner group G0 is N+1, and the quantity of the memory chips CM0, . . . , CMN in the partner group GM is N+1.

In another embodiment, the quantities of the memory chips in the partner groups can be different. For example, the quantity of the memory chips in one partner group can be N+1, and the quantity of the memory chips in another partner group can be N.

In step S520, the processing unit 920 requires at least one of the memory chips in each of the partner groups to serve a reading request or a writing request. For example, the processing unit 920 may require one memory chip in each of the partner groups to serve the reading request or the writing request. If most of the memory chips C00, . . . , C0N, except the memory chip C00, are being performed the garbage collection operation, the wear-leveling operation or the refresh operation at the same time, the processing unit 920 will require the memory chip C00 to be served for the reading request or the writing request. That is to say, if another garbage collection operation is requested, the memory chip C00 will not be performed this garbage collection operation.

In another embodiment, the processing unit 920 may require more than one memory chips in each of the partner groups to serve the reading request or the writing request. For example, the processing unit 920 may require the memory chips C00 and C0N to be served for the reading request or the writing request, if other memory chips are being performed the garbage collection operation, the wear-leveling operation or the refresh operation at the same time.

In this step, at least one of the memory chips C00, . . . , C0N is dynamically selected. The at least one of the memory chips C00, . . . , C0N which is required to serve the reading request and the writing request is not predetermined at the beginning.

Please refer to FIG. 6, which illustrates an exemplary example of the memory controlling method. Four memory chips C60, C61, C62, C63 are grouped into two partner groups G90, G91. Eight writing requests W0, W1, W2, W3, W5, W6, W7, W9, W10 and two garbage collection operations GC4, GC8 are inputted. At first, the memory chips C60, C61, C62, C63 are written according to the writing requests W0, W1, W2, W3 respectively. Next, the memory chip C60 is performed the garbage collection operation GC4 and the memory chip C61 is required to be served for the reading request or the writing request at this time. Then, the memory chips C61, C62, C63 are written according to the writing requests W5, W6, W7 respectively. Afterwards, because the memory chip C61 is required to be served for the reading request or the writing request, so the garbage collection operation GC8 cannot be performed on the memory chip C61. Therefore, the garbage collection operation GC8 is performed on the memory chip C62, and the memory chip C63 is required to be served for the reading request or the writing request at this time. Next, the memory chips C63, C61 are written according to the writing requests W9, W10 respectively.

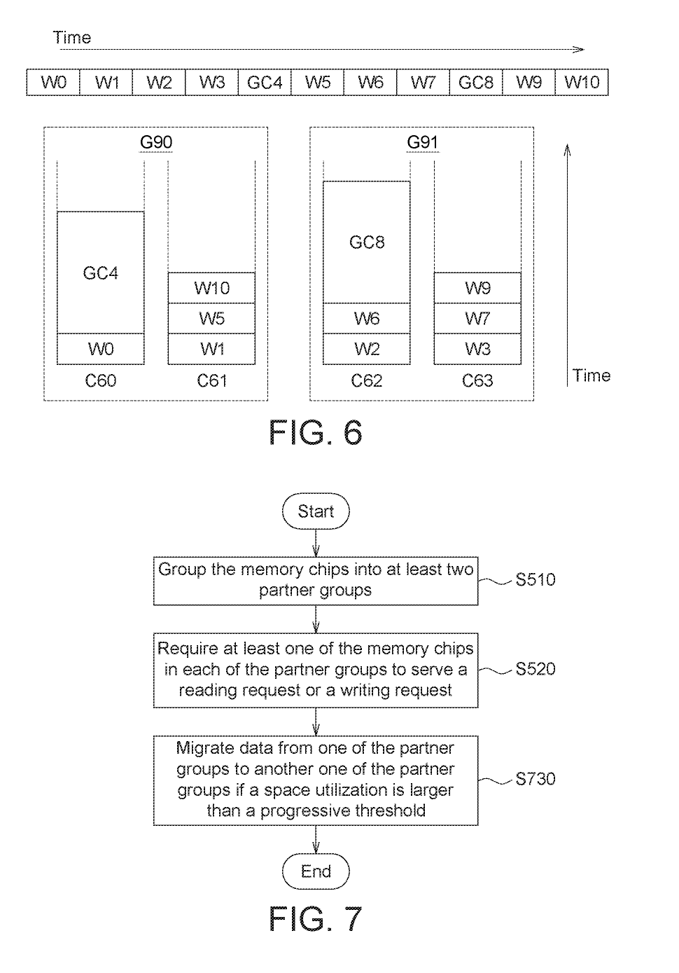

Referring to FIG. 3, after a period of time, the space utilizations of the partner groups G0, . . . , GM may be uneven. To balance the space utilizations, migration may be used to avoid cold data from being centered in some of the memory chips G0, . . . , GM. Please refer to FIG. 7, which shows a flowchart of a memory controlling method. The memory controlling method of FIG. 7 further includes step S730. In S730, the processing unit 920 migrates data from one of the partner groups G0, . . . , GM to another one of the partner groups G0, . . . , GM if a space utilization is larger than a progressive threshold. The progressive threshold is calculated according to the following equation (1).

$$TH = {T}_{init} + \frac{{T}_{end} - {T}_{init}}{{T}_{end}} * {U}_{avg} \qquad ( 1 )$$

TH is the progressive threshold, Tᵢₙₜ, is the lowest space utilization of a memory chip to activate cold data migration, T_{end} is the highest space utilization allowed in a memory chip, and U_{avg} is the average space utilization.

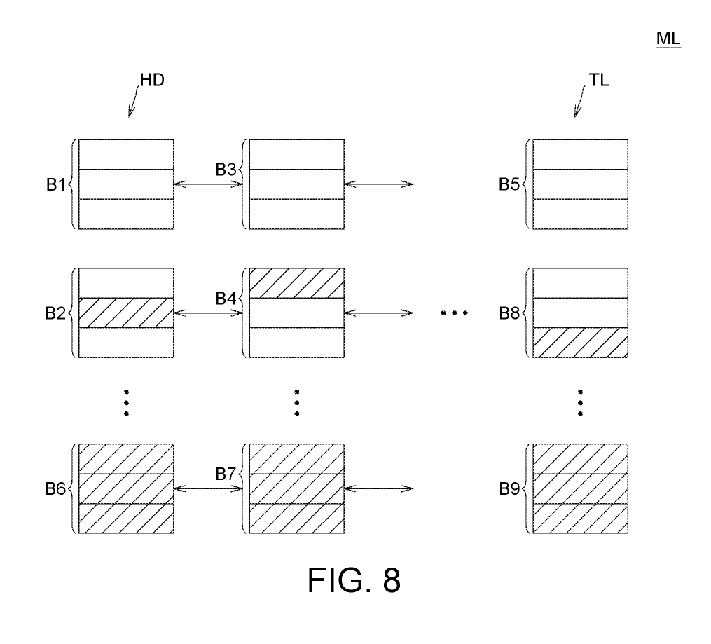

In the step S730, the a plurality of blocks of one of the memory chips are ranged in a multi-level linked list ML in accordance with an amount of valid pages, and the data is migrated according to the multi-level linked list ML. For example, please refer to FIG. 8, which illustrates the multi-level linked list ML. Each of the blocks B1 to B9 includes three pages. The block B1, the block B3 and the block B5 are arranged at the top level of the multi-level linked list ML, the block B2, the block B4 and the block B8 are arranged at the second level of the multi-level linked list ML, and the block B6, the block B7 and the block B9 are arranged at the bottom level of the multi-level linked list ML. In the multi-level linked list ML, new unit is inserted to the head HD and the desired unit is captured from the tail TL.

The large unit, such as blocks B1 to B9, is selected from the bottom level in the multi-level linked list ML for migration due to the large amount of valid small unit, such page/sector. In FIG. 8, the valid pages are marked in slash. The blocks B6, B7, B9 at the bottom level will be selected first for migration.

The large unit, such as blocks B1 to B9, is selected from the top level in the multi-level linked list ML for the garbage collection operation, the wear-leveling operation or the refresh operation due to the small amount of valid small unit, such as page/sector. In FIG. 8, the blocks B1, B3, B5 at the top level will be selected first for the garbage collection operation, the wear-leveling operation or the refresh operation.

By performing the migration, cold data will not be centered in some of the memory chips and the space utilizations can be balanced the space utilizations.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A memory controlling method, wherein a memory includes a plurality of memory chips and the memory controlling method comprises:
grouping, by a grouping unit, the memory chips into at least two partner groups, wherein a quantity of the memory chips in each of the partner groups is at least two; and
requiring, by a processing unit, at least one of the memory chips in each of the partner groups to serve a reading request or a writing request.

2. The memory controlling method according to claim 1, wherein a quantity of the memory chips in one of the partner groups is N+1, and at most N of the memory chips are being performed a garbage collection operation, a wear-leveling operation or a refresh operation at the same time.

3. The memory controlling method according to claim 1, wherein the at least one of the memory chips which is required to serve the reading request and the writing request is selected from some of the memory chips which are not performed a garbage collection operation, a wear-leveling operation or a refresh operation.

4. The memory controlling method according to claim 1, wherein quantities of the memory chips in the partner groups are identical.

5. The memory controlling method according to claim 1, wherein quantities of the memory chips in the partner groups are different.

6. The memory controlling method according to claim 1, further comprising:
migrating, by a migrating unit, data from one of the partner groups to another one of the partner groups if a space utilization is larger than a progressive threshold.

7. The memory controlling method according to claim 6, wherein in the step of migrating data, a plurality of blocks of one of the memory chips are ranged in a multi-level linked list in accordance with an amount of valid pages, and the data is migrated according to the multi-level linked list.

8. The memory controlling method according to claim 1, wherein the memory is a nonvolatile memory.

9. A memory controlling circuit, wherein a memory includes a plurality of memory chips, and the memory controlling circuit comprises:
a grouping unit for grouping the memory chips into at least two partner groups, wherein a quantity of the memory chips in each of the partner groups is at least two; and
a processing unit for requiring at least one of the memory chips in each of the partner groups to serve a reading request or a writing request.

10. The memory controlling circuit according to claim 9, wherein a quantity of the memory chips in one of the partner groups is N+1, and at most N of the memory chips are being performed a garbage collection operation, a wear-leveling operation or a refresh operation at the same time.

11. The memory controlling circuit according to claim 9, wherein the at least one of the memory chips which is required to serve the reading request and the writing request is selected from some of the memory chips which are not performed a garbage collection operation, a wear-leveling operation or a refresh operation.

12. The memory controlling circuit according to claim 9, wherein quantities of the memory chips in the partner groups are identical.

13. The memory controlling circuit according to claim 9, wherein quantities of the memory chips in the partner groups are different.

14. The memory controlling circuit according to claim 9, further comprising:
a migrating unit for migrating data from one of the partner groups to another one of the partner groups if a space utilization is larger than a progressive threshold.

15. The memory controlling circuit according to claim 14, wherein a plurality of blocks of one of the memory chips are ranged in a multi-level linked list in accordance with an amount of valid pages, and the migrating unit migrates the data according to the multi-level linked list.

16. The memory controlling circuit according to claim 1, wherein the memory is a nonvolatile memory.

17. A memory system, comprising:
a plurality of memory chips; and
a memory controlling circuit, including:
a grouping unit for grouping the memory chips into at least two partner groups, wherein a quantity of the memory chips in each of the partner groups is at least two; and
a processing unit for requiring at least one of the memory chips in each of the partner groups to serve a reading request or a writing request.

18. The memory system according to claim 17, wherein a quantity of the memory chips in one of the partner groups is N+1, and at most N of the memory chips are being performed a garbage collection operation, a wear-leveling operation or a refresh operation at the same time.

19. The memory system according to claim 17, wherein the at least one of the memory chips which is required to serve the reading request and the writing request is selected from some of the memory chips which are not performed a garbage collection operation, a wear-leveling operation or a refresh operation.

20. The memory system according to claim 17, wherein the memory controlling circuit further comprises:
a migrating unit for migrating data from one of the partner groups to another one of the partner groups if a space utilization is larger than a progressive threshold.
